(19) United States
(12) Patent Application Publication
(10) Pub. No.: US 2008/0055436 A1
(43) Pub. Date: Mar. 6, 2008

(54) Method, imager and system providing paired-bayer color filter array and interlaced readout

(76) Inventors: Atif Sarwari, Saratoga, CA (US); Steinar Iversen, Oslo (NO); Brian Rodricks, Los Gatos, CA (US)

Correspondence Address: DICKSTEIN SHAPIRO LLP, 1825 EYE STREET, NW, WASHINGTON, DC, 20006, US

(21) Appl. No.: 11/511,207

(22) Filed: Aug. 29, 2006

(51) Int. Cl. H04N 9/04

(52) U.S. Cl. 348/272

(57) ABSTRACT

A pixel array, composed of rows and columns, has a first row which includes pixels of a first color alternating with pixels of a second color. A second row of the array adjacent to the first row includes alternating pixels of the first color and second colors aligned in a column direction with the colors in the first row. A third row of the array is adjacent to the second row and includes pixels of a third color alternating with pixels of a fourth color. A fourth row of the array is adjacent to the third row and includes alternating pixels of the third and fourth colors aligned in a column direction with the colors of the third row. A readout circuit is connected to the array and reads out the pixel signals contained in each row in an odd/even interlaced fashion.

### FIELD OF THE INVENTION

Embodiments of the present invention relate to color filters and readout of solid state imagers.

### BACKGROUND OF THE INVENTION

Solid state imagers were developed in the late 1960s and early 1970s. An imager absorbs incident radiation of a particular wavelength (such as optical photons, x-rays, or the like) and generates electrical signals corresponding to the absorbed radiation. There are a number of different types of semiconductor-based imagers, including those based on charge coupled devices (CCDs), photodiode arrays, charge injection device (CID arrays), hybrid focal plan arrays, and complementary metal oxide semiconductor (CMOS) arrays.

These imagers typically have an array of pixels containing photosensors, where each pixel produces a signal corresponding to the intensity of light impinging on that element when an image is focused on the array. The signals may then be digitized and stored, for example, for display of a corresponding image on a monitor or for providing hardcopy images or otherwise used to provide information about an image. The photosensors are typically phototransistors, photoconductors or photodiodes. The magnitude of the signal produced by each pixel is proportional to the amount of light impinging on the photosensor.

To allow the photosensors to capture a color image, the photosensors must be able to separately detect color components of a captured image. For example when using a Bayer pattern (shown in FIG. 1), red (R) photons, green (G) photons and blue (B) photons are detected by respective red, green, and blue pixels. Accordingly, each pixel will be sensitive only to one color or spectral band. For this, a color filter array (CFA) is typically placed in front of the pixel array so that each pixel receives the light of the color of its associated filter according to a specific pattern (e.g., the noted Bayer Pattern) other color filter array patterns are also known in the art.

For most low cost CMOS or CCD pixel arrays, the color filters are integrated with the photosensors over a common substrate. A common example of a color filter pattern is the Bayer tiled color filter array illustrated in U.S. Pat. No. 3,971,065 and FIG. 1.

As shown in FIG. 1, the Bayer pattern 100 is an array of repeating red (R), green (G), and blue (B) filters. A red pixel is a pixel covered by a red filter, similarly, a blue pixel and a green pixel are pixels covered by blue and green filters respectively. The pixels of FIG. 1 may be identified by coordinates A_{xy} to identify the color and the location of the pixel within the pixel array, where the A indicates the color (R for red, B for blue, G for green), the x indicates the row, and the y indicates the column.

In the Bayer pattern 100, red, green and blue pixels are arranged so that alternating red and green pixels are on a first row 105 of an array, and alternating blue and green pixels are on a next row 110. These alternating rows are repeated throughout the array. Thus, when the image sensor is read out, the pixel sequence for one row reads GRGRGR, etc., and the next row sequence reads BGBGBG, etc. While FIG. 1 depicts an array having 5 rows and 6 columns, pixel arrays typically have many more rows and columns of pixels.

In the Bayer pattern 100, the three basic colors are adjusted according to the acuity of the human visual system. That is, green color, to which the human eye is most sensitive and responsive, is sensed with a larger number of sensors, whereas blue and red color, for which the human vision has less sensitivity, are sensed with a fewer number of sensors.

For an output image, values for red, green and blue are necessary for each pixel location. Since each pixel of an image sensor array is only sensing one color, values for the remaining two colors are interpolated from the neighboring pixels that are sensing the missing colors. This color interpolation is known as demosaicing. For example, with reference to FIG. 1, pixel G35 (reference 115) is associated with a green filter, which causes pixel G35 to sense green light and produce a signal that represents only green light. In order to obtain an approximation of the amount of red and blue light for pixel G35, a value may be interpolated from the neighboring red pixels R34 (reference 120) and R36 (reference 125) and the neighboring blue pixels B25 (reference 130) and B45 (reference 135), respectively.

In addition, each of the pixels of an array experiences optical interference, or crosstalk, from its neighboring pixels. The magnitude of the effect of crosstalk on a specific pixel is a function of several factors including the distance between the pixel and the neighboring pixels. For example, the crosstalk for green pixel G33 (reference number 140 in FIG. 1) can be represented as:

G33_{crosstalk}≅k(R32_{crosstalk}+R34_{crosstalk})+k√2(G22_{crosstalk}+G24_{crosstalk}+G42_{crosstalk}+G44_{crosstalk})+k(B23_{crosstalk}+B43_{crosstalk}), and can be simplified to:

G33_{crosstalk}≅k(2)R_{crosstalk}+k(4/√2)G_{crosstalk}+k(2)B_{crosstalk}, where k=a constant.

G33_{crosstalk}≅the crosstalk for green pixel G42 (reference number 145) which can be represented as:

G42_{crosstalk}≅k(R32_{crosstalk}+R52_{crosstalk})+k√2(G31_{crosstalk}+G33_{crosstalk}+G51_{crosstalk}=G53_{crosstalk})+k(B41_{crosstalk}+B43_{crosstalk}), and can be simplified to:

G42_{crosstalk}≅k(2)R_{crosstalk}+k(4/√2)G_{crosstalk}+k(2)B_{crosstalk}, where k≅a constant. Since the crosstalk for pixels G33 and G42 each include the same portion of R_{crosstalk} and B_{crosstalk}, the Bayer color filter array can be considered immune to crosstalk-driven imbalance for green pixels (also referred to as cross-talk Green imbalance).

In imager pixel arrays employing a Bayer pattern the pixel rows are typically read out in a progressive manner. In other words, referring to FIG. 1, the charge for the pixels located in row 150 are read out first, followed by the charge for the pixels located in row 155, followed by the charge for the pixels located in rows 160, 165 and 170. In this manner the values are read out of the array 100 from top to bottom. In a CMOS imager, for example, all of the pixels of a row are read out simultaneously onto respective column lines.

An important performance characteristic of pixel arrays is dynamic range. A large dynamic range is desirable in applications for sensing low and high light signals. The dynamic range of a pixel may be defined as the ratio of the minimum illuminance the pixel detects under saturation to the illuminance the pixel detects at a signal-to-noise ratio (SNR) equal to one, or expressed as the ratio of the image sensor's highest illumination level to its lowest illumination level. In the context of an imager pixel, integration time refers to the time period during which a charge accumulates in a region of a photosensor as a result of the exposure of the pixel to incident light. A wider dynamic range enables a pixel to better capture high and low light signals during the integration time.

An interlaced readout may be used to obtain the signals from an array of pixels for video applications. One example of interlacing occurs when the values for all odd pixel rows are read out in sequence first and then the values for all even pixel rows are read out in sequence. Again referring to FIG. 1, during an interlaced readout the values for pixels corresponding to G11, R12, G13, R14, G15, and R16 in row 150 are read out, followed by a readout of the values for pixels corresponding to G31, R32, G33, R34, G35, R36 of row 160, etc. Once all of the pixel values for all odd rows are read out, the values for all even rows are read out beginning with row 155 of FIG. 1.

In order to perform demosaicing when an interlaced readout stream is used with a Bayer color filter pattern, values for three adjacent rows must be available at the same time. Referring again to FIG. 1, in order to perform demosaicing for pixel G35, pixel values for row 160 (providing values for pixels R34, G35 and R36) and pixel values for rows 155 and 165 (proving values for pixels B25 and B45 respectively) must be available at the same time. One method for providing demosaicing with an interlaced readout stream used with a Bayer pattern is to stored the pixel values of read rows in a field buffer. After both odd and even rows are stored the demosaicing can begin. For example, if a frame rate of 30 frames per second is desired, the frame rate would be double to 60 frames per second and demosaicing would be performed. Unfortunately, this second approach increases readout time and limits the maximum time available for signal integration. Limiting the maximum integration time results in a low-light-sensitivity penalty, which is undesirable.

One system which may be used for an interlaced odd, even field readout of a sold-state imager is illustrated in FIG. 2. FIG. 2 is a block diagram of a CMOS imager integrated circuit (IC) 200 having a pixel array 205 containing a plurality of pixels arranged in rows and columns, including a region 210 with, for example, two green pixels (G), one blue pixel (B), and one red pixel (R) arranged in the Bayer pattern shown in FIG. 1. The pixels of each row in array 205 are all turned on at the same time by row select lines 215, and the pixels of each column are selectively output by respective column select lines 220.

The row lines 215 are selectively activated by a row driver 225 in response to row address decoder 230. The column select lines 220 are selectively activated by a column selector 235 in response to column address decoder 240. The pixel array 205 is operated by the timing and control circuit 245, which controls address decoders 230, 240 for selecting the appropriate row and column lines for pixel signal readout.

The pixel column signals, which typically include a pixel reset signal (Vᵣₛₜ) and a pixel image signal (V_{sig}), are read by a sample and hold circuit 250 associated with the column selector 235. A differential signal (Vᵣₛₜ−V_{sig}) is produced by differential amplifier 255 for each pixel that is amplified and digitized by analog-to-digital converter 270 (ADC). The analog-to-digital converter 270 supplies the digitized pixel signals to an image processor 275, which may be a series of hardware circuits, or software run on a processor, or a combination of both.

For many applications such as back up cameras or rear view mirrors for vehicles, and for security cameras, a real time video display of clear images acquired under low light situations is desired.

### BRIEF DESCRIPTION OF THE DRAWINGS

FIG. 1 is a top-down illustration of a conventional Bayer color filter array;

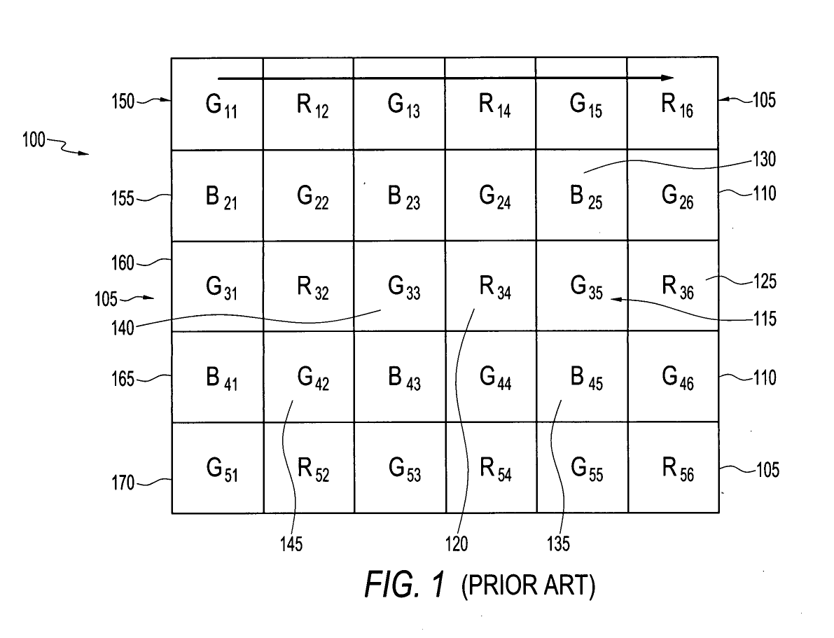

FIG. 2 is a block diagram of a CMOS imager integrated circuit (IC) having a pixel array;

FIG. 3 is a top down illustration of a paired-Bayer color filter array in accordance with an embodiment of the invention;

FIG. 4 is a diagram illustrating the interlaced readout of the paired-Bayer color filter array of FIG. 3;

FIG. 5 depicts a rolling shutter integration window of each sensor row of an interlaced readout of a Paired Bayer Pattern for NTSC Mode in accordance with an embodiment of the invention; and

FIG. 6 is a block diagram of a processor system, for example a camera system, according to an embodiment of the invention.

### DETAILED DESCRIPTION OF THE INVENTION

In the following detailed description, reference is made to the accompanying drawings which form a part hereof, and in which is shown by way of illustration specific embodiments of the invention. These embodiments are described in sufficient detail to enable those skilled in the art to practice the embodiment, and it is to be understood that other embodiments may be utilized, and that structural, logical and electrical changes may be made.

The term “pixel” refers to a picture element unit cell containing a photosensor for converting light radiation to an electrical signal and associated structures for providing an output signal from the pixel.

It should be understood that embodiments are described in the context of CMOS imager. It should be readily apparent that the invention is not limited to CMOS imagers, but also applies to CCD imagers and other solid state imagers that employ color filters over pixels. Additionally, the embodiments are described using a standard three color Bayer pattern; it should be understood however, that the embodiments are not limited to the standard three color Bayer pattern, but may be applied to color spaces which use different colors or which use more, or less, than three colors.

As discussed, the integration period is the period in which charge is accumulated at a photo sensor of a pixel while the pixel is exposed to incident light. Selection of an integration time has typically been a compromise between low light performance and avoiding saturation of the pixel at high brightness conditions. One way to improve the low light performance of a pixel is to increase the integration period. Some embodiments of the invention allow for longer integration times while maintaining a fast readout and demosaicing operation, and are particular suitable for video applications.

In embodiments of the invention, the Bayer pattern is replaced with a paired-Bayer pattern and an interlaced readout is used. In a paired-Bayer pattern, two successive rows containing the GRGRGRGR, etc. pattern are followed by two successive rows containing the BGBGBGBG, etc. pattern. This pattern is repeated through all rows of the array. For example, the pixels in both rows 1 and 2 contain the GRGRGRGR pattern while the pixels in both rows 3 and 4 contain the BGBGBGBG pattern. The values of the pixels are read out in an interlace fashion in which all odd rows are read out first followed by all even rows (or visa versa). As further described below, the combination of the paired-Bayer pattern with the odd/even row interlaced readout permits an improvement in low light performance of the image sensor by allowing the integration time to span the entire frame as readout and demosaicing can be done at video rates.

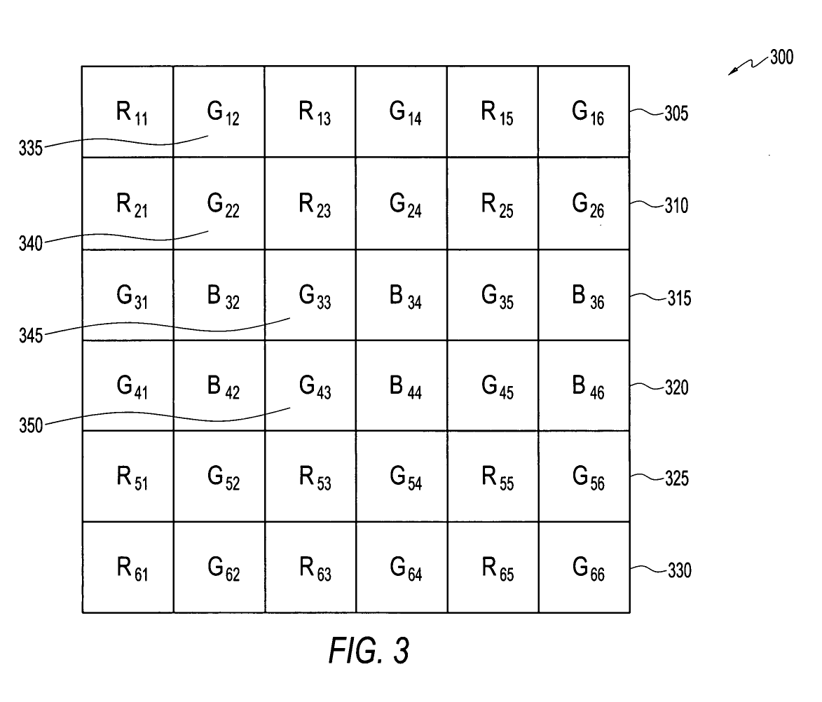

FIG. 3 is a top down illustration of a pixel array having a paired-Bayer color filter array (CFA) 300 formed over a pixel array in accordance with an embodiment of the invention. Each color filter is associated with a respective pixel. The pixels of FIG. 3 have coordinates A_{xy} to identify the color and the location of the pixel within the pixel array, where the A indicates the color (R for red, B for blue, G for green), the x indicates the row, and the y indicates the column. The pixel array includes odd rows 305, 315 and 325 and even rows 310, 320 and 330. As shown, rows 305, 310, 325 and 330 contain the identical pixel sequences RGRGRG, etc. and rows 315 and 320 contain the identical pixel sequences GBGBGB, etc. While FIG. 3 depicts a 6×6 array, as implemented the array includes many more pixels, for example the array may be implemented with e.g., 640 columns and 480 rows, or another size.

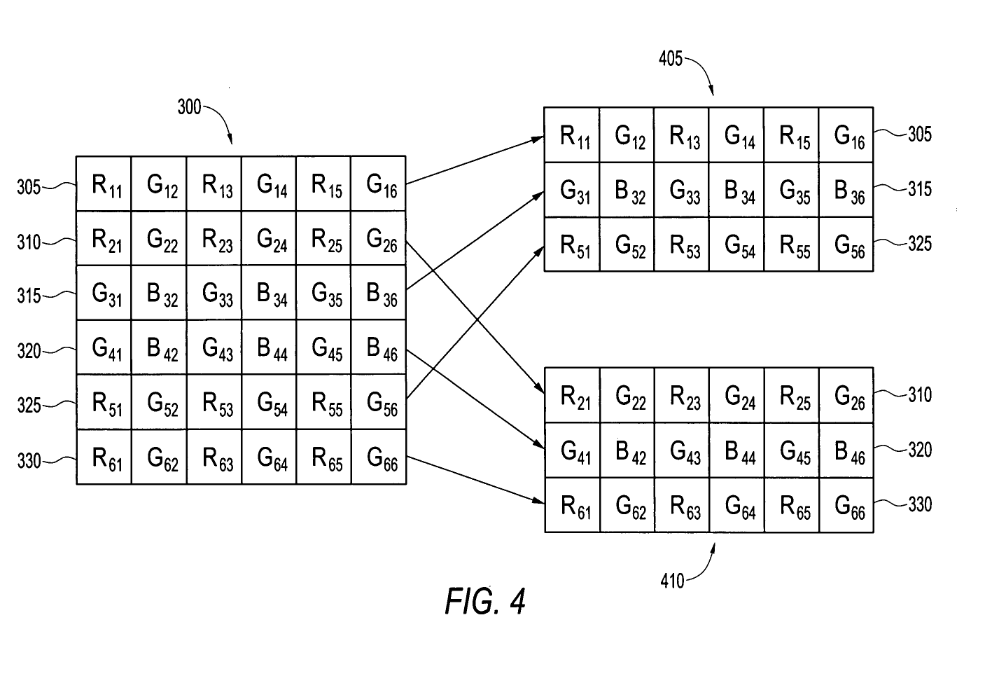

As shown in FIG. 4, the pixel array readout format is interlaced in that the odd rows are read out first (reference number 405), followed by the even rows (reference number 410), though the even rows could be read first followed by the odd rows. In this embodiment, odd rows 305, 315 and 325 are read out first, followed by even rows 310, 320 and 330. Thus, for the odd row fields the pixel sequence RGRGRG in one row is read out first followed by a row containing the pixel sequence GBGBGB. As a result both the odd fields and the even field contain successive read out rows contain alternating patterns of RGRGRG, etc and GBGBGB, etc. The use of the interlaced readout with the paired-Bayer filter pattern results in a conventional Bayer pattern pixel stream for each odd and even field to the image flow processor 275, since the rows are still read out in the same order as in a standard Bayer pattern, i.e. a row of RGRGRG being read out and followed by a row of GBGBGB. Additionally, the combination of the paired-Bayer pattern with the interlaced readout provides for an integration time capable of spanning substantially a full frame time (33 milliseconds for NTSC and 40 milliseconds for PAL), resulting in the ability to extend the integration times for improved low-light sensitivity.

Each pixel associated with the paired-Bayer CFA experiences crosstalk from its neighboring pixels as in a conventional Bayer pattern readout. The magnitude of the effect of crosstalk on a specific pixel is a function of the distance between the pixel and the neighboring pixels.

For example, the crosstalk for pixel G22 (reference number 340 of FIG. 3) is:

G22_{crosstalk}≅k(R21+R23 +(√2)R11+(√2)R13)+k(G12+(√2)G32+(√2)G33)+k(B32), which can be simplified as:

G22_{crosstalk}≅(2+(2/√2))R_{crosstalk}+k(1+2/⇄2)G_{crosstalk}+k(1)B_{crosstalk}, where k=a constant.

However, the crosstalk for pixels G33 (reference numbers 345 of FIG. 3) is:

G33_{crosstalk}≅k(B32+B34+(√2)B44+(√2)B44)+k(G43+(√2)G22+(√2)G24)+k(R23), which can be simplified as:

G33_{crosstalk}≅k(2+(2/√2))B_{crosstalk}+k(1+2/√2)G_{crosstalk}+k(1)R_{crosstalk}, where k=a constant. Now, if R_{crosstalk} is larger than B_{crosstalk} a significant difference between pixels G22 and G33 may lead to a “checkerboard effect.” Accordingly, the paired-Bayer CFA 300 may have a crosstalk-driven green imbalance. The effects of the crosstalk-driven green imbalance, however can be reduced by using pixels having low electrical and optical crosstalk.

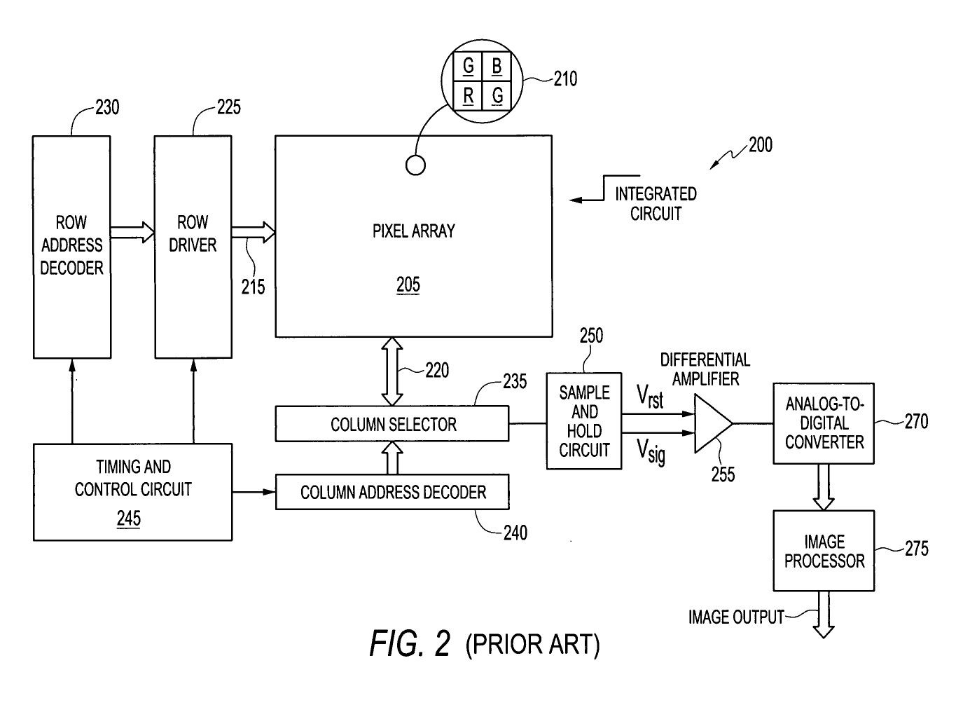

One advantage of the paired-Bayer array with interlaced readout is that the readout circuitry does not require a frame buffer to hold an entire image field before demosaicing can commence. Instead, demosaicing can occur as each of the odd and even fields are read out, by for example, into image flow processor 275, such as depicted in FIG. 2. As noted earlier, demosaicing can occur on pixels of a middle row when there are three rows of pixel information on pixels. Then a three line buffer can be used in which a new row of pixel signals is added while an oldest row is discarded.

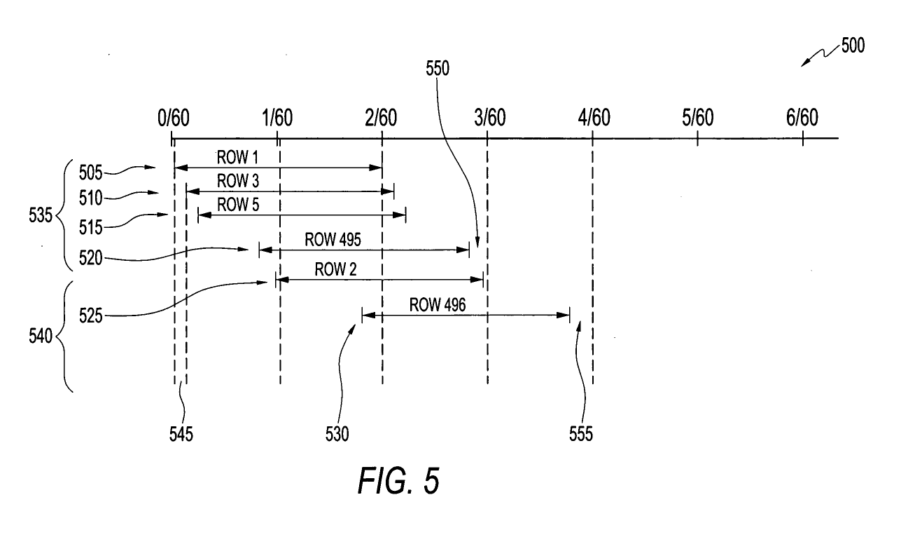

FIG. 5 depicts a rolling shutter integration window of each pixel array row of an interlaced readout of pixels arranged in a paired-Bayer pattern for the NTSC mode. In the interlaced readout, the odd rows are read out first followed by the even rows. As depicted in FIG. 5, the rolling shutter exposure-window of the odd rows 535 begins with Row 1 (reference number 505), continues with Row 3 (reference number 510) and remaining odd rows and is completed with Row 595 (reference number 520). The integration window for Row 1 (the first active row) begins at 0 seconds and is completed at 2/60 seconds or 33.33 milliseconds. In one embodiment of the rolling shutter readout, the time shift per row is 1/(30*525) or approximately 63.49 microseconds. After the appropriate time shift, the integration window for row 3 (the second active,row) beings and is completed after 33.3 milliseconds. After the integration period of the last odd row, e.g., 595 in this example, is begun, the rolling shutter exposure-windows for the even rows begins, with row 2 (reference number 525) and is completed with the exposure of row 496 (reference number 530). Also depicted in FIG. 5 is the odd row vertical blanking period 550 and even row vertical blanking period 555. The staggered pixel readout sequence with a paired-Bayer CFA allows the integration time to span a full frame (while streaming Bayer content). This combination yields a two times improvement at low-light performance because the integration time can span the whole frame ( 1/30 seconds or 33.3 milliseconds) as opposed to a 60 frame/second integration period required with a Bayer pattern ( 1/60 seconds or 16.6 milliseconds). The offset may be kept low even at long integration periods by the use of a pixel with low dark current.

It should be noted that while the integration window for pixel photo sensors may extend up to an entire frame, light conditions may cause an automatic exposure system to reduce the integration period.

Embodiments of the invention may be implemented in a CMOS imager device of the type illustrated in FIG. 2 with the pixel array 205 modified to have the paired-Bayer pattern discussed with reference to FIG. 3 and with the timing and control circuit of FIG. 5 causing timing and control circuit 245 to produce an interlaced odd/even row readout described herein. The image processor 275 which may be implemented in hardware or software or a combination of the two, receives the interlaced pixel signals and performs the demosaicing operation.

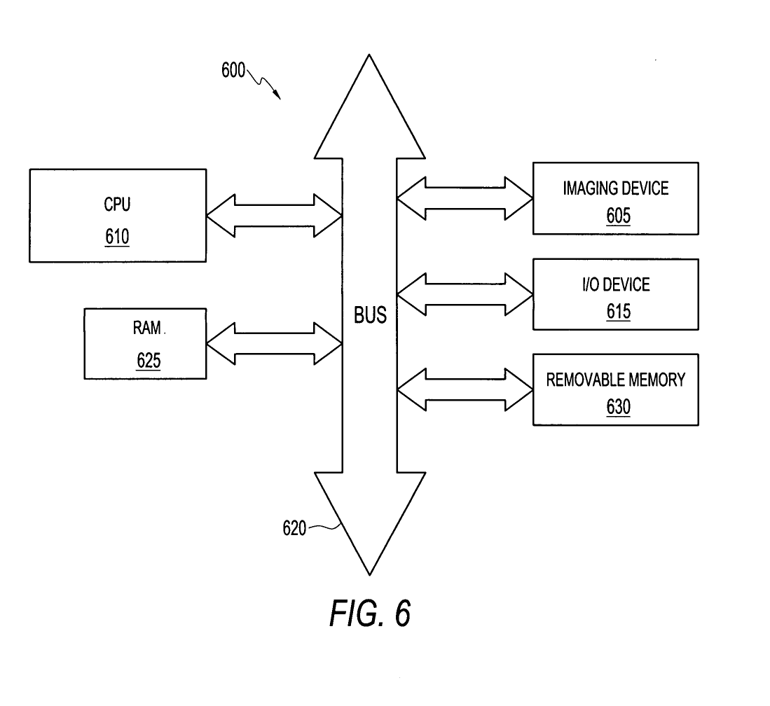

FIG. 6 is a block diagram of a processor system, for example, a still or video camera system, according to an exemplary embodiment of the invention. A typical processor system 600 includes an imager device 605 having a pixel array and associated paired-Bayer pixel pattern as described above. The imager device 605 produces an output image from signals supplied from the pixel array. Although processor system 600 is described as a camera system it could also be any other processing system that requires image input such as a computer system, scanner, machine vision system, medical sensor system (such as medical pill sensors), and automotive diagnostic system, and other imaging systems, all of which can utilize the present invention.

A processor based system 600, such as a camera system, for example generally comprises a central processing unit (CPU) 610, for example, a microprocessor, for controlling camera functions, that communicates with one or more input/output (I/O) devices 615 over a bus 620. The imager device 605 also communicates with the CPU 610 over bus 620 or other communication link. The camera system 600 also includes random access memory (RAM) 625, and, may include peripheral devices such as a removable memory 630, for example a flash memory card, which also communicate with CPU 610 over the bus 620. It may also be desirable to integrate the processor 610, imager device 605 and memory 625 on a single IC chip.

The above description and drawings are only to be considered illustrative exemplary embodiments of the invention.

What is claimed as new and desired to be protected by Letters Patent of the United States is:

1. A pixel array comprising:
a plurality of pixels arranged in rows and columns,
a first row of the array including pixels of a first color alternating with pixels of a second color;
a second row of the array adjacent to said first row including pixels of the first color alternating with pixels of the second color, wherein pixels within the same column of the first and second rows are of the same color;
a third row of the array adjacent to the second row including pixels of a third color alternating with pixels of a fourth color; and
a fourth row of the array adjacent to the third row including pixels of the third color alternating with pixels of the fourth color, wherein pixels within the same column of the third and fourth rows are of the same color.

2. The pixel array of claim 1 wherein the first color and the third color are of the same color.

3. The pixel array of claim 2 wherein the pixels within the same column of the second and third rows are of different colors

4. The pixel array of claim 2 wherein the first and third color are green, the second color is blue and the fourth color is red.

5. An imaging device comprising:
a pixel array containing color pixels arranged into rows and columns with alternating first and second pairs of adjacent rows;
said first pair of adjacent rows having pixels along each of said first pair of adjacent rows which alternate between first and second colors;
said second pair of adjacent rows having pixels along each of said second pair of adjacent rows which alternate between third and fourth colors;
a readout circuit for reading out signals from all the odd rows of said array as a group and for reading out signals from all even rows of said array as a group.

6. The imaging device of claim 5 wherein said first and third colors are the same color.

7. The imaging device of claim 5 wherein the first pair of adjacent rows have identical colors in a column.

8. The imaging device of claim 7 wherein the second pair of adjacent rows have identical colors in a column.

9. The imaging device of claim 5 wherein an integration time for each pixel may span up to a full video frame.

10. The imaging device of claim 5 wherein the signals are read out in an interlaced manner in which the interlaced readout results in the values of all odd rows being read out first followed by the values of all even rows being read out second.

11. The imaging device of claim 5 wherein the signals are read out in an interlaced manner in which the interlaced readout results in the values of all odd rows being read out first followed by the values of all even rows being read out second by use of a rolling shutter readout.

12. The imaging device of claim 5 further including means for demosaicing such that values for the first, second, third and fourth colors are determined for each pixel.

13. The imaging device of claim 5 wherein the first and third color are green, the second color is blue and the fourth color is red.

14. A camera comprising:
(i) a processor for operating said camera; and
(ii) an image device coupled to the processor, the image device comprising:
an array of pixels arranged in rows and columns, wherein the pixel array is arranged in a paired-Bayer pattern, wherein said paired-Bayer pattern includes:
a first row of the array including pixels of a first color alternating with pixels of a second color;
a second row of the array adjacent to said first row including pixels of the first color alternating with pixels of the second color, wherein pixels within the same column of the first and second rows are of the same color;
a third row of the array adjacent to the second row including pixels of a third color alternating with pixels of a fourth color; and
a fourth row of the array adjacent to the third row including pixels of the third color alternating with pixels of the fourth color, wherein pixels within the same column of the third and fourth rows are of the same color; and
(iii) a readout circuit for reading out the pixels in said array in an interlaced fashion.

15. The camera of claim 14 wherein the integration time for each pixel may span up to a full video frame.

16. The camera of claim 14 wherein the interlaced fashion for the readout includes reading out the values for all odd rows first followed by reading out the values for all even rows second.

17. The camera of claim 14 wherein the interlaced fashion for the readout includes reading out the values for all odd rows first followed by reading out the values for all even rows second by use of a rolling shutter readout.

18. The camera of claim 14 wherein the first and third colors are the same color.

19. The camera of claim 18 wherein the first row of adjacent pixels are aligned with the second row of adjacent pixels such that the first and second rows have identical colors in a column.

20. The camera of claim 19 wherein the third row of adjacent pixels are aligned with the fourth row of adjacent pixels such that the third and fourth rows have identical colors in a column.

21. The camera of claim 14 wherein the first and third color are green, the second color is blue and the fourth color is red.

22. A method of generating an image, the method comprising:
capturing an image with a pixel array such that each pixel stores charge proportional to the amount of light received by the pixel during an integration period; said pixels of said array being arranged as follows:
(i) a first row of the array including pixels of a first color alternating with pixels of a second color;
(ii) a second row of the array adjacent to said first row including pixels of the first color alternating with pixels of the second color, wherein pixels within the same column of the first and second rows are of the same color;
(iii) a third row of the array adjacent to the second row including pixels of a third color alternating with pixels of a fourth color; and
(iv) a fourth row of the array adjacent to the third row including pixels of the third color alternating with pixels of the fourth color, wherein pixels within the same column of the third and fourth rows are of the same color;
reading the stored charge out of the pixel array in an interlaced manner; and
generating the image from the stored charges.

23. The method of claim 22 wherein the interlaced manner for reading stored charge out includes reading the stored charge out of the pixels in all odd rows first followed by reading the stored charge out of the pixels in all even rows.

24. The camera of claim 22 wherein the interlaced manner for the readout includes reading out the values for all odd rows first followed by reading out the values for all even rows.

25. The method of claim 22 wherein the integration time for each pixel spans a full video frame.

26. The pixel array of claim 22 wherein said interlaced readout results in the values of all even rows being read out first followed by the values of all odd rows being read out second.

27. The pixel array of claim 22 wherein the first and third color are green, the second color is blue and the fourth color is red.

28. A method for demosaicing an image captured by a pixel array, the method comprising:
a method of generating pixel signals in a pixel array, the pixel array having:
(i) a first row including pixels of a first color alternating with pixels of a second color;
(ii) a second row adjacent to said first row including pixels of the first color alternating with pixels of the second color, wherein pixels within the same column of the first and second rows are of the same color;
(iii) a third row adjacent to the second row including pixels of a third color alternating with pixels of a fourth color; and
(iv) a fourth row adjacent to the third row including pixels of the third color alternating with pixels of the fourth color, wherein pixels within the same column of the third and fourth rows are of the same color;
reading the stored charge out of the pixel array in an interlaced manner; and
determining a value for each of the first, second, third and fourth colors for each pixel of the array.

29. The method of claim 28 wherein reading the stored charge out of the pixel array is performed in an interlaced manner including reading the stored charge out of the pixels in all odd rows first followed by reading the stored charge out of the pixels in all even rows.

30. The method of claim 28 wherein the integration time for each pixel spans a full video frame.
